(19) United States
(12) Patent Application Publication
(10) Pub. No.: US 2023/0392394 A1
(43) Pub. Date: Dec. 7, 2023

(54) SCAFFOLD

(71) Applicant: Sekisui House, Ltd., Osaka-Shi, Osaka (JP)

(72) Inventors: Masaki Watanabe, Osaka-shi (JP); Hideki Suzuki, Osaka-shi (JP); Hideki Watanabe, Osaka-shi (JP)

(73) Assignee: Sekisui House, Ltd., Osaka-Shi, Osaka (JP)

(21) Appl. No.: 18/032,009

(22) PCT Filed: Oct. 20, 2020
(86) PCT No.: PCT/JP2020/039397

§ 371 Date: Apr. 14, 2023

(51) Int. Cl. E04G 5/16; E04G 5/14; E04G 1/36; E04G 1/15

(52) U.S. Cl. CPC E04G 5/16; E04G 5/14; E04G 1/36; E04G 1/15

(57) ABSTRACT

A scaffold provided with a running board part and a reinforcing member which is attached to at least one end of the running board part in the width direction of the running board part. The reinforcing member has a pair of extension parts which extend in the longitudinal direction of the running board and which are disposed apart from each other in the vertical direction, and a plurality of connecting parts which are disposed at intervals in the longitudinal direction and which connect the pair of extension parts.

### TECHNICAL FIELD

The present disclosure relates to a scaffold.

### BACKGROUND ART

When constructing an architectural structure, one may assemble a scaffold around the architectural structure so that work can be done in a high place. Patent Literature 1 discloses an example of a conventional scaffold member.

### CITATION LIST

### Patent Literature

Patent Literature 1: UK Patent Application Publication No. 2188666

### SUMMARY OF INVENTION

### Technical Problem

A scaffold includes a step board portion having any length. However, when the step board portion is long and an intermediate part of the step board portion is not supported by a support pole, the step board portion may be bent by the weight of a worker.

### Solution to Problem

(1) A scaffold according to the present disclosure includes a step board portion and a reinforcement member coupled to at least one end of the step board portion in a width-wise direction of the step board portion. The reinforcement member includes two extensions spaced apart from each other in a vertical direction and extending in a longitudinal direction of the step board portion and coupling portions spaced apart from each other in the longitudinal direction and coupling the two extensions.

In this structure, the step board portion is supported by the reinforcement member arranged in the longitudinal direction of the step board portion. Thus, bending of the step board portion is limited.

(2) In the scaffold according to the foregoing description (1), the coupling portions include at least a first coupling portion, a second coupling portion located adjacent to the first coupling portion, and a third coupling portion located adjacent to the first coupling portion at a side opposite the second coupling portion, and a distance between the first coupling portion and the second coupling portion is equal to a distance between the first coupling portion and the third coupling portion.

This structure limits bending of the two extensions of the reinforcement member. Thus, the step board portion is supported further appropriately.

(3) In the scaffold according to the foregoing description (1) or (2), the extensions and the coupling portions are integrally formed.

In this structure, the two extensions and the coupling portions of the reinforcement member are integrally formed. This increases the strength of the reinforcement member. Thus, the step board portion is supported further appropriately.

(4) The scaffold according to any one of the foregoing descriptions (1) to (3) further includes support members that support the reinforcement member.

In this structure, the reinforcement member is supported by multiple support members and thus further appropriately supports the step board portion.

(5) In the scaffold according to the foregoing description (4), the support members and the reinforcement member are joined by a joining portion.

In this structure, the support members and the reinforcement member are joined further appropriately.

(6) The scaffold according to the foregoing description (4) or (5) further includes an auxiliary support member disposed between the support members and coupled to the reinforcement member. The auxiliary support member supports the step board portion.

In this structure, the step board portion is supported further appropriately.

(7) In the scaffold according to any one of the foregoing descriptions (1) to (6), the step board portion includes step boards.

In this structure, the step board portion includes multiple step boards. This allows for adjustment of the width of the step board portion. Thus, usability is improved.

### Advantageous Effects of Invention

According to the present disclosure, the scaffold limits bending of the step board portion.

### BRIEF DESCRIPTION OF DRAWINGS

FIG. 1 is a diagram showing the appearance of a house under construction with arrangement of an embodiment of a scaffold.

FIG. 2 is a perspective partial view of the scaffold showing a scaffold reinforcement unit including reinforcement members.

FIG. 3 is a side view of one of the reinforcement members shown in FIG. 2.

FIG. 4 is a diagram of the scaffold shown in FIG. 1 schematically showing the scaffold reinforcement unit including the reinforcement members.

### DESCRIPTION OF EMBODIMENTS

### Embodiment

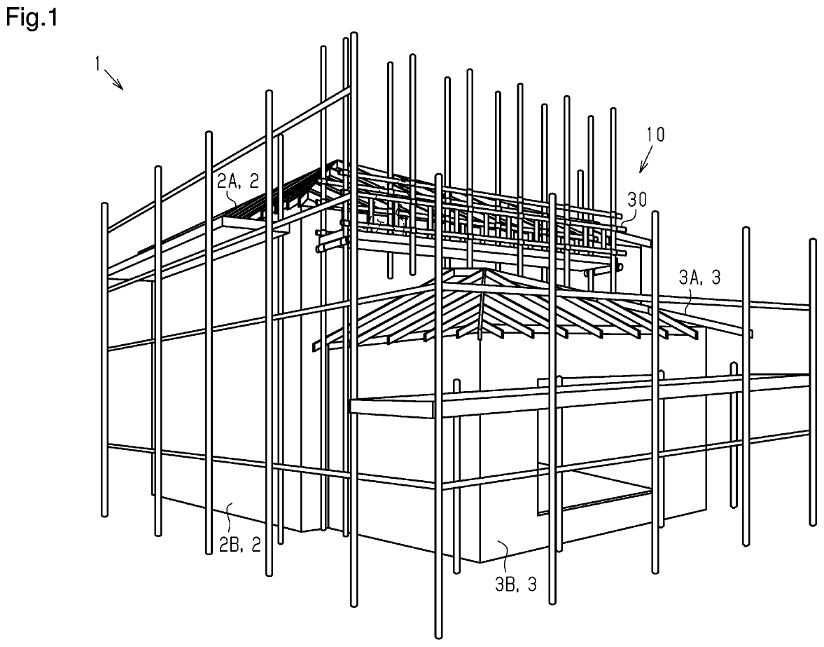

An embodiment of a scaffold 10 will be described with reference to FIGS. 1 to 4. When an architectural structure 1 is constructed, the scaffold 10 is arranged around the architectural structure 1. When the architectural structure 1 is constructed, the scaffold 10 is used for the purpose of movement of a worker, as a work space of the worker, and as a storage space for materials forming the architectural structure 1. The architectural structure 1 is, for example, a house including a first structural part 2 and a second structural part 3. The first structural part 2 includes a first roof 2A and a first exterior wall 2B. The first roof 2A is parallel to or inclined from a horizontal direction. In an example, the first structural part 2 includes multiple floors. The second structural part 3 includes a second roof 3A and a second exterior wall 3B. The second roof 3A is parallel to or inclined from a horizontal direction. The second roof 3A is located at a lower position than the first roof 2A.

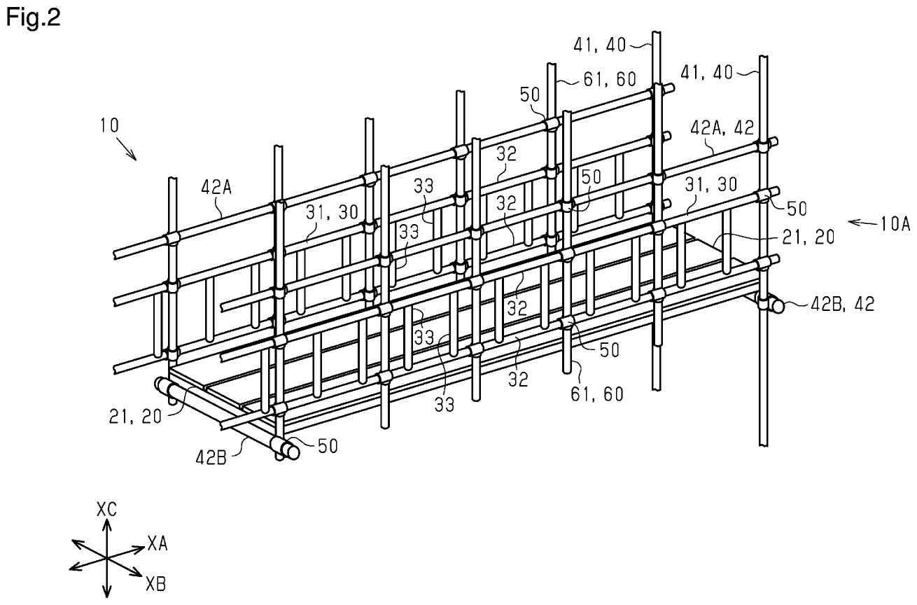

FIG. 2 is a diagram of a scaffold reinforcement unit 10A including reinforcement members 30 showing an enlarged view of an end of the scaffold reinforcement unit 10A. The scaffold 10 includes a step board portion 20 and the reinforcement members 30. The step board portion 20 includes one or more step boards 21. The step boards 21 are formed of a material suitable for supporting the materials forming the architectural structure 1 and workers. In an example, the step boards 21 are formed of metal or wood. When the step board portion 20 includes multiple step boards 21, the step boards 21 may be arranged in a longitudinal direction XA of the step board portion 20 or may be arranged in a width-wise direction XB of the step board portion 20. The step boards 21 may be stacked on each other. Preferably, the step boards 21 are identical to each other in dimensions. In the example shown in FIG. 2, three step boards 21 are arranged in the width-wise direction XB of the step board portion 20.

The reinforcement members 30 are coupled to at least one end of the step board portion 20 in the width-wise direction XB of the step board portion 20. The reinforcement members 30 may be directly coupled to the step board portion 20. The reinforcement members 30 are coupled to the step board portion 20, for example, by a clamp holding a lower portion of the reinforcement members 30 and the end of the step board portion 20 in the width-wise direction XB. The reinforcement members 30 may be indirectly coupled to the step board portion 20. The reinforcement members 30 are coupled to the step board portion 20, for example, by an auxiliary support member 60, which will be described later. In the example shown in FIG. 2, the reinforcement members 30 are coupled to both ends of the step board portion 20 in the width-wise direction XB. Each reinforcement member 30 includes a body 31. The body 31 includes two extensions 32 and a coupling portion 33 that couples the extensions 32. The body 31 is formed from, for example, metal. The two extensions 32 and the coupling portion 33 may be integrally formed. The extensions 32 and the coupling portion 33 may be coupled by any coupling process. In an example of being integrally formed, the two extensions 32 are welded to the coupling portion 33. Example of any coupling process include adhering with an adhesion and coupling with a nut and a blot.

The scaffold 10 further includes support members 40. The support members 40 support the step board portion 20 and the reinforcement members 30. The support members are disposed on the ground. The support members 40 may be disposed on a base or a structure disposed on the ground. The structure includes another scaffold, the skeleton of the second structural part 3 of the architectural structure 1, and the foundation of the architectural structure 1. The step board portion 20 and the reinforcement members 30 are fastened to the support members 40 by clamps. The support members 40 include, for example, a support pole 41. Multiple support poles 41 are configured to be disposed orthogonal to the ground. The support poles 41 are formed from, for example, metal. The support poles 41 are connected to each other by connection poles 42. The connection poles 42 and the support poles 41 are formed of, for example, the same type of metal. One of the support poles 41 supports a first end of the step board portion 20 in the longitudinal direction. Another one of the support poles 41 supports a second end of the step board portion 20 that is opposite the first end in the longitudinal direction.

The connection poles 42 include a first connection pole 42A disposed in the longitudinal direction XA of the step board portion 20 and a second connection pole 42B disposed in the width-wise direction XB of the step board portion 20. The first connection pole 42A may be used as, for example, a handrail for a worker on the step board portion 20 and a guard rail that prevents the worker from falling. The second connection pole 42B supports the step boards 21. A first connection process for connecting the first connection pole 42A to the support pole 41 may differ from a second connection process for connecting the second connection pole 42B to the support pole 41. The first connection process is, for example, tightening with a rope. The second connection process is, for example, fastening with a screw or a bolt.

The reinforcement member 30 is joined to the support member 40 and supported on the support member 40 by a joining portion 50. In an example, the joining portion 50 includes a clamp. In another example, the joining portion 50 includes a rope used in a tightening process or an adhesion used in an adhering process.

The scaffold 10 further includes the auxiliary support member 60. The auxiliary support member 60 supports the step board portion 20 via the second connection pole 42B. The auxiliary support member 60 is disposed between the support members 40. The auxiliary support member 60 is coupled to the reinforcement member 30 by the joining portion 50. The auxiliary support member 60 is coupled to the second connection pole 42B by the joining portion 50 without being in contact with the ground. The auxiliary support member 60 includes auxiliary support poles 61. The auxiliary support poles 61 are disposed at predetermined intervals between the support poles 41 in the longitudinal direction XA of the step board portion 20. The auxiliary support poles 61 and the support poles 41 are formed of, for example, the same type of metal. The auxiliary support member 60 is also coupled to the first connection pole 42A by the joining portion 50.

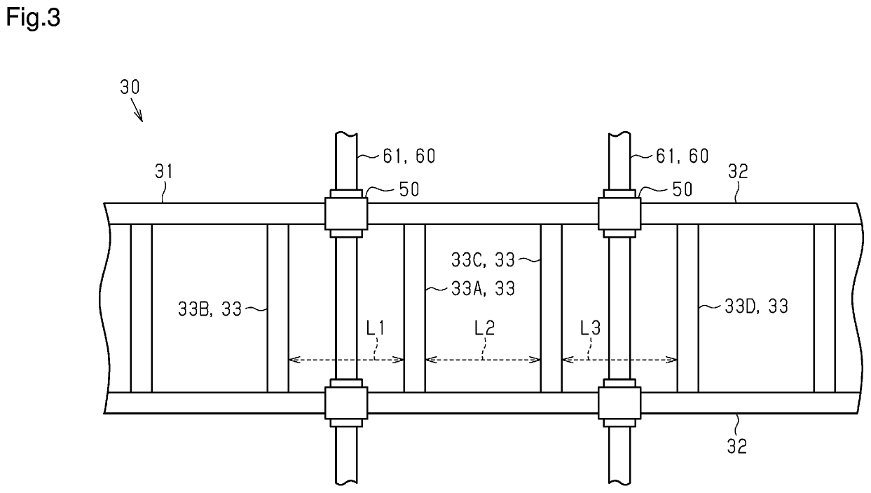

The structure of the reinforcement member 30 will now be described in detail with reference to FIG. 3. The two extensions 32 are coupled by multiple coupling portions 33. Preferably, the distance between the two extensions 32 is constant. The coupling portions 33 include at least a first coupling portion 33A, a second coupling portion 33B located adjacent to the first coupling portion 33A in the longitudinal direction XA, and a third coupling portion 33C located adjacent to the first coupling portion 33A in the longitudinal direction XA at a side opposite the second coupling portion 33B. In the illustrated example, a fourth coupling portion 33D is located adjacent to the third coupling portion 33C in the longitudinal direction at a side opposite the first coupling portion 33A. A distance L1 between the first coupling portion 33A and the second coupling portion 33B is equal to a distance L2 between the first coupling portion 33A and the third coupling portion 33C. A distance L3 between the third coupling portion 33C and the fourth coupling portion 33D is equal to the distance L1 and the distance L2. The distance between the two extensions 32, the number of coupling portions 33, and the distances L1 to L3 are set in accordance with the length of the step board portion 20 in the longitudinal direction XA. In an example, the length of the step board portion 20 in the longitudinal direction XA is five meters. Each of the distances L1 to L3 is, for example, 300 millimeters.

In an example, the position of an auxiliary support pole 61 coupled to the reinforcement member 30 is an intermediate position between any two of the coupling portions 33 in the longitudinal direction XA. In another example, the position of an auxiliary support pole 61 coupled to the reinforcement member 30 conforms to the position of any one of the coupling portions 33 in the longitudinal direction XA.

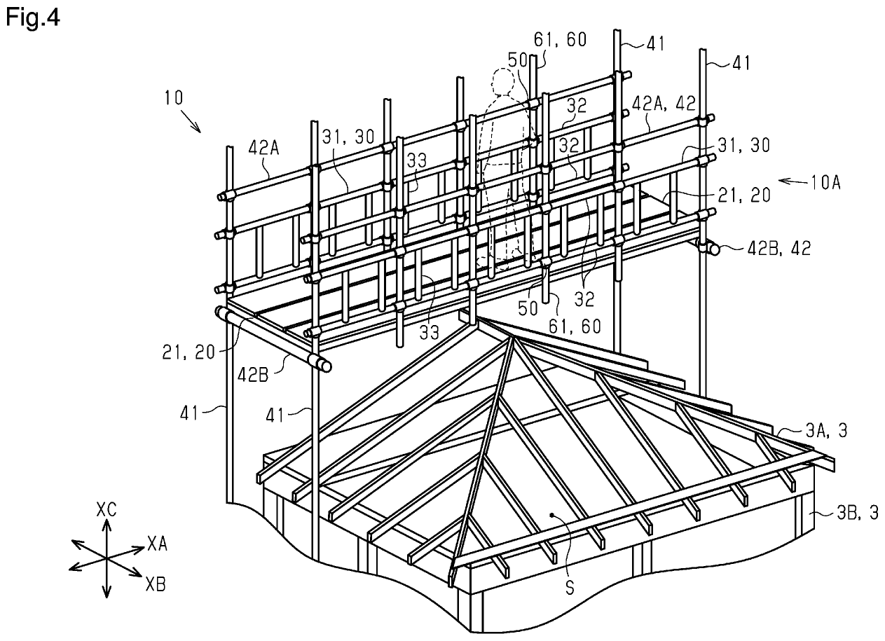

The operation of the scaffold 10 of the embodiment will now be described with reference to FIG. 4.

One disposes the support poles 41 at an outer side of the second exterior wall 3B of the second structural part 3. More specifically, the support poles 41 are disposed so that the second structural part 3 is located between a set of support poles 41 and another set of support poles 41. Two of the support poles 41 located in the longitudinal direction XA are connected by the reinforcement member 30 and the first connection pole 42A so that the reinforcement member 30 and the first connection pole 42A are disposed above the second structural part 3. Two of the support poles 41 located in the width-wise direction XB are connected by a second connection pole 42B. The step boards 21 are disposed on the second connection poles 42B to provide the step board portion 20. The step board portion 20 is disposed at a higher position than the second roof 3A of the second structural part 3 in a vertical direction XC. A roofing task of the second roof 3A of the second structural part 3 is not completed, and an interior space S defined by rafters and the second exterior wall 3B is open. The reinforcement member 30 is arranged on at least one end of the step board portion 20 in the width-wise direction XB. This limits bending of the step board portion 20 even when the support members 40 are not arranged on the second roof 3A or in the interior space S defined by the second exterior wall 3B.

The advantages of the scaffold 10 of the embodiment will now be described.

(1) The scaffold of the present embodiment includes the step board portion 20 and the reinforcement member 30 coupled to at least one end of the step board portion 20 in the width-wise direction XB of the step board portion 20. The reinforcement member 30 includes the two extensions 32 spaced apart from each other in the vertical direction XC and extending in the longitudinal direction XA of the step board portion 20 and the coupling portions 33 spaced apart from each other in the longitudinal direction XA and coupling the extensions 32.

In this structure, the reinforcement member 30, arranged in the longitudinal direction XA of the step board portion 20, supports the step board portion 20. When one works on the step board portion 20 or materials are placed on the step board portion 20, a perpendicular force acts on the step board portion 20 and may bend the step board portion 20. In the scaffold of the present embodiment, the step board portion 20 is disposed on at least one end of the step board portion 20 in the width-wise direction XB. Thus, bending of the step board portion 20 is limited even when a perpendicular force acts on the step board portion 20.

(2) The coupling portions 33 include at least the first coupling portion 33A, the second coupling portion 33B located adjacent to the first coupling portion 33A, and the third coupling portion 33C located adjacent to the first coupling portion 33A at a side opposite the second coupling portion 33B. The distance L1 between the first coupling portion 33A and the second coupling portion 33B is equal to the distance between the first coupling portion 33A and the third coupling portion 33C.

This structure limits a force acting on a particular portion of the two extensions 32, thereby limiting bending of the extensions 32. Thus, the step board portion 20 is supported further appropriately.

(3) The extensions 32 and the coupling portions 33 are integrally formed.

In this structure, the two extensions 32 and the coupling portions 33 of the reinforcement member 30 are integrally formed. This improves stress of the reinforcement members 30 against external force. Thus, the step board portion 20 is supported further appropriately.

(4) The support members 40 supporting the reinforcement member 30 are further included.

In this structure, the reinforcement member 30 is supported by the support members 40. Thus, the step board portion 20 is supported further appropriately.

(5) The support member 40 and the reinforcement member 30 are joined by the joining portion 50.

In an example, the joining portion 50 includes a clamp. When the support member and the reinforcement member 30 are joined by a clamp, the support member 40 and the reinforcement member 30 are easily joined. Also, when changing the position of the reinforcement member 30, the support member 40 and the reinforcement member 30 are also easily disjoined. Thus, the support member 40 and the reinforcement member 30 are joined further appropriately.

(6) The auxiliary support member 60 is further included and disposed between the support members 40 and coupled to the reinforcement member 30. The auxiliary support member 60 supports the step board portion 20.

In this structure, the step board portion 20 is further supported by the auxiliary support member 60. Thus, the step board portion 20 is supported further appropriately.

(7) The step board portion 20 includes multiple step boards 21.

In this structure, the step board portion 20 is formed of the step boards 21. The step boards 21 may be added or removed as necessary so that the workspace of the worker has any area. This improves usability.

(8) The scaffold 10 of the present embodiment limits bending of the step board portion 20. This allows the distance between the support members 40 to be increased in the longitudinal direction XA of the step board portion 20. Thus, when the step board portion 20 is located at a position higher than the second roof 3A of the second structural part 3 in a height-wise direction, the support members 40 do not need to be disposed on the second roof 3A or in the interior space S defined by the second exterior wall 3B. When constructing the architectural structure 1, construction tasks are simultaneously performed on the first structural part 2 and the second structural part 3. This shortens the construction time of the architectural structure 1. The construction tasks of the second structural part 3 include a decorating task of the interior space S of the second structural part 3 and a roofing task of the second roof 3A.

(9) The scaffold 10 of the present embodiment supports the step board portion 20 with a small number of support members 40 As a result, the materials necessary for assembling the scaffold 10 and the assembly time are reduced, so that the cost and time for constructing the architectural structure 1 are reduced.

### Modified Examples

The description related with the above embodiment exemplifies, without any intention to limit, applicable forms of a scaffold according to the present disclosure. In addition to the embodiment described above, the scaffold according to the present disclosure is applicable to, for example, modified examples of the above embodiment that are described below and combinations of at least two of the modified examples that do not contradict each other.

An additional step board portion 20 may be further arranged at an upper side of the step board portion 20 in the vertical direction XC and separated from the step board portion 20. The additional step board portion 20 is used, for example, during the roofing task of the first structural part 2. The additional step board portion 20 is supported by the support member 40 and the auxiliary support member 60. Preferably, at least one end of the additional step board portion 20 in the width-wise direction XB is further supported by the reinforcement member 30.

### REFERENCE SIGNS LIST

1) architectural structure; 2) main house; 2A) main house roof; 2B) main house wall; 3) lean-to; 3A) lean-to roof; 3B) lean-to wall; 10) scaffold; 10A) scaffold reinforcement unit; 20) step board portion; 21) step board; 30) reinforcement member; 31) body; 32) extension; 33) coupling portion; 33A) first coupling portion; 33B) second coupling portion; 33C) third coupling portion; 33D) fourth coupling portion; 40) support member; 41) support pole; 42) connection pole; 42A) first connection pole; 42B) second connection pole; 50) joining portion; 60) auxiliary support member; 61) auxiliary support pole; XA) longitudinal direction; XB) width-wise direction; XC) vertical direction; L1) distance; L2) distance; L3) distance

1. A scaffold comprising:
a step board portion; and
a reinforcement member coupled to at least one end of the step board portion in a width-wise direction of the step board portion, wherein
the reinforcement member includes
two extensions spaced apart from each other in a vertical direction and extending in a longitudinal direction of the step board portion, and
coupling portions spaced apart from each other in the longitudinal direction and coupling the two extensions.

2. The scaffold according to claim 1, wherein
the coupling portions include at least a first coupling portion, a second coupling portion located adjacent to the first coupling portion, and a third coupling portion located adjacent to the first coupling portion at a side opposite the second coupling portion, and
a distance between the first coupling portion and the second coupling portion is equal to a distance between the first coupling portion and the third coupling portion.

3. The scaffold according to claim 1, wherein the extensions and the coupling portions are integrally formed.

4. The scaffold according to claim 1, further comprising:
support members that support the reinforcement member.

5. The scaffold according to claim 4, wherein the support members and the reinforcement member are joined by a joining portion.

6. The scaffold according to claim 4, further comprising:
an auxiliary support member disposed between the support members and coupled to the reinforcement member, wherein the auxiliary support member supports the step board portion.

7. The scaffold according to claim 1, wherein the step board portion includes step boards.
